(19) United States
(12) Patent Application Publication
(10) Pub. No.: US 2020/0099489 A1
(43) Pub. Date: Mar. 26, 2020

(54) METHOD AND APPARATUS FOR CONFIGURING REFERENCE SIGNAL OF A WIRELESS COMMUNICATION SYSTEM

(71) Applicant: Cloud Network Technology Singapore Pte. Ltd., Singapore (SG)

(72) Inventor: Mitsuo Sakamoto, HSINCHU (TW)

(21) Appl. No.: 16/574,502

(22) Filed: Sep. 18, 2019

Related U.S. Application Data
(60) Provisional application No. 62/734,616, filed on Sep. 21, 2018.

(51) Int. Cl. H04L 5/00; H04B 7/08; H04W 74/08; H04L 1/00

(52) U.S. Cl. CPC H04L 5/0048; H04B 7/0857; H04L 1/0003; H04L 1/0026; H04W 74/0833

(57) ABSTRACT

A method for configuring a reference signal in a wireless communication system includes a base station receiving a plurality of uplink sequences from an uplink channel and performing an optimal combining procedure on the plurality of uplink sequences to output a result of combined uplink sequences. The base station determines channel signature information based on the combined result, and detects a plurality of complex signals at peak positions from the plurality of uplink sequences based on the channel signature information. The base station further estimates a first correlation level based on the plurality of complex signals and coherently accumulates a second correlation level based on the first correlation level. A density of the reference signal and MCS based on the second correlation level is then determined.

### CROSS-REFERENCE TO RELATED APPLICATIONS

The application claims the benefit and priority to U.S. Provisional Application No. 62/734,616 filed on Sep. 21, 2018, and entitled “A Method of Adaptive Reference Signal Configuration and Channel Measurement of an Uplink Transmission of a Wireless Communication System”, the entire contents of which are incorporated by reference herein.

### FIELD

The subject matter herein generally relates to wireless communications.

### BACKGROUND

The fifth generation (5G) new radio (NR) wireless communication system supports a wide spectrum, from below 1 GHz to more than 30 GHz (e.g., millimeter wave). The system must use a variety of radio frequency components in order to support the wide spectrum and the characteristics of the components are different from each other. In addition, the 5G NR wireless communication system has to support high-speed mobility, which is up to 500 km/h. As the maximum Doppler frequency becomes higher when millimeter wave is used, it is very difficult to support all deployment scenarios with only one frame format.

Thus, there is room for improvement within the art.

### BRIEF DESCRIPTION OF THE DRAWINGS

Implementations of the present technology will now be described, by way of embodiment, with reference to the attached figures, wherein:

FIG. 1 is a schematic diagram of one embodiment of a radio transmission model of a wireless communication system.

FIG. 2 is a flow chart of one embodiment of a method of configuring a reference signal of the wireless communication system of FIG. 1.

FIG. 3 is a flow chart of another embodiment of the method.

FIG. 4 is a flow chart of one embodiment of a method of configuring a reference signal with physical random access channel (PRACH).

FIG. 5 is a flow chart of one embodiment of a method of configuring a reference signal with physical uplink control channel (PUCCH).

FIG. 6 is a schematic diagram of one embodiment of resource allocation of a physical uplink control channel (PUCCH) format with a frequency hopping feature in the system of FIG. 1.

FIG. 7 is a schematic diagram of one embodiment of a detection of a PUCCH.

FIG. 8 is a schematic diagram of another embodiment of a configuration of a reference signal of the wireless communication system of FIG. 1.

FIG. 9 is a schematic diagram of another embodiment of a configuration of a reference signal of the wireless communication system of FIG. 1

FIG. 10 is a flow chart of another embodiment of a method of configuring the reference signal.

FIG. 11 is a schematic diagram of another embodiment of a configuration of a reference signal of the wireless communication system of FIG. 1.

FIG. 12 is a flow chart of another embodiment of a method of configuring a reference signal.

FIG. 13 is a schematic diagram of another embodiment of a reference signal configuration of the wireless communication system of FIG. 1.

FIG. 14 is a schematic diagram of another embodiment of a configuration of a reference signal of the wireless communication system of FIG. 1.

FIG. 15 is a schematic diagram of one embodiment of a coherent accumulation procedure of the wireless communication system of FIG. 1.

FIG. 16 is a schematic diagram of one embodiment of a measuring period conversion procedure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout the present disclosure will now be presented. The term “coupled” is defined as connected, whether directly or indirectly through intervening components, and is not necessarily limited to physical connections. The connection can be such that the objects are permanently connected or releasably connected. References to “an” or “one” embodiment in this disclosure are not necessarily to the same embodiment, and such references mean “at least one”.

In the present disclosure, a base station may include, but is not limited to, a node B (NB) as in the Universal Mobile Telecommunication System (UMTS), as in the LTE-A, a radio network controller (RNC) as in the UMTS, a base station controller (BSC) as in the GSM (Global System for Mobile Communication)/GERAN (GSM EDGE Radio Access Network), an ng-eNB as in an Evolved Universal Terrestrial Radio Access (E-UTRA) base station in connection with the 5G Core Network (5GC), a next generation node B (gNB) as in the 5G Access Network (5G-AN), an RRH (Remote Radio Head), a TRP (transmission and reception point), a cell, and any other apparatus capable of configuring radio communication and managing radio resources within a cell. The base station may serve one or more UE(s) through a radio interface to the network.

In the present disclosure, a UE may include, but is not limited to, a mobile station, a mobile terminal or device, and a user communication radio terminal. For example, a UE may be a portable radio equipment, which comprises, but is not limited to, a mobile phone, a tablet, a wearable device, a sensor, a personal digital assistant (PDA) with wireless communication capability, and other wireless device equipped with an LTE access module or a 5G NR (New Radio) access module. In the present disclosure, the UE is configured to communicate with a radio access network via the base station.

The UE and the base station may include, but is not limited to, a transceiver, a processor, a memory, and a variety of computer-readable media. The transceiver may have transmitter and receiver configured to transmit and/or receive data. The processor may process data and instructions. The processor may include an intelligent hardware device, e.g., a central processing unit (CPU), a microcontroller, and an ASIC. The memory may store computer-readable, computer-executable instructions (e.g., software codes) that are configured to cause processor to perform various functions. The memory may include volatile and/or non-volatile memory. The memory may be removable, non-removable, or a combination thereof. Exemplary memories include solid-state memory, hard drives, optical-disc drives, and etc. The computer storage media stores information such as computer-readable instructions, data structures, program modules, and other data. The computer-readable media can be any available media that can be accessed and include both volatile and non-volatile media, removable and non-removable media. By way of example, and not limitation, the computer-readable media may comprise computer storage media and communication media. The computer storage media includes RAM, ROM, EEPROM, flash memory, other memory technology, CD-ROM, digital versatile disks (DVD) or other optical disk storage, magnetic cassettes, magnetic tape, magnetic disk storage, and other magnetic storage devices.

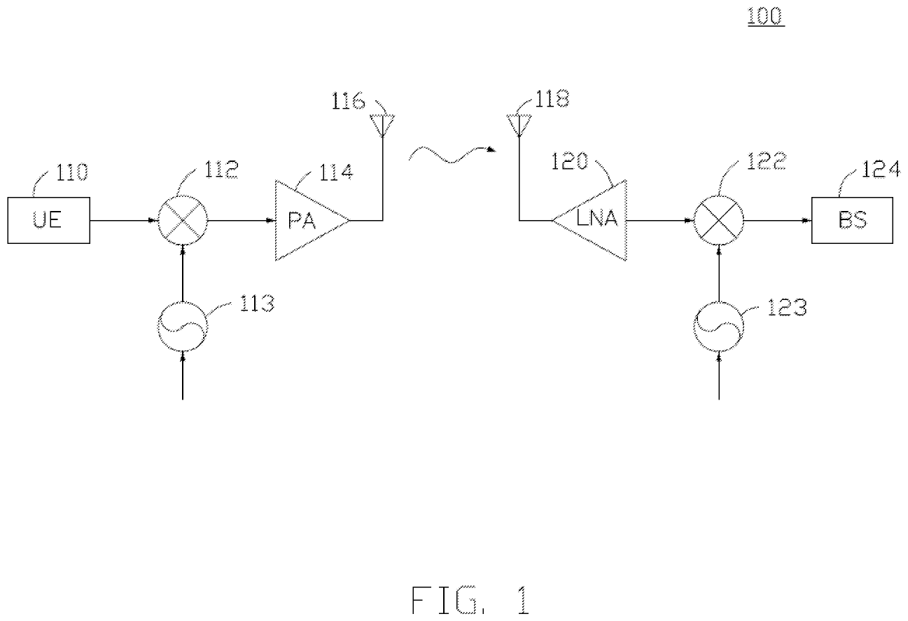

FIG. 1 illustrates a radio transmission model of a wireless communication system 100 according to an exemplary implementation. The wireless communication system 100 comprises a UE 110 and a base station (BS) 124. In the wireless communication system 100, the UE 110 transmits a signal which may be influenced by a mixer 112, an oscillator 113, a power amplifier (PA) 114, and an antenna 116 on the transmitter (TX) side. The BS 124 receives the signal which may be influenced by an antenna 118, a low-noise amplifier (LNA) 120, a mixer 122, and an oscillator 123 on the receiver (RX) side. The RF components between TX and RX, e.g., the mixers 112 and 122, the oscillators 113 and 123, the PA 114, the LNA 120, and the antennas 116 and 118 can cause RF analog error.

Such error may be of three kinds, a carrier frequency offset, a phase noise, and Doppler shift caused by UE mobility, these errors must be taken into account as the RF analog error. The carrier frequency offset between TX and RX is caused by implementation of a separate reference clock oscillator (e.g., oscillators 113 and 123). The phase noise is generated by the local oscillators 113 and 123 (e.g., PLL implementation), which is characterized by a low frequency region and a high frequency region. The phase noise of the low frequency region shows similar effects with the frequency offset error. Some advanced AFC (Automatic Frequency Controller) can compensate for such errors. The phase noise of the high frequency region is different from the phase noise of the low frequency region. The coherence time of the high frequency region phase noise is shorter than that of the low frequency region phase noise depending on carrier frequency. The Doppler frequency or the Doppler spread depends on the carrier frequency, the UE mobility and an angle of arrival when beamforming is used. When the higher carrier frequency such as millimeter wave is used, the coherence time of the Doppler shift, which has similar statistical characteristics (or similar value) to the coherence time of the high frequency region phase noise, is short. Long term behaviors of high frequency region phase noise and Doppler shift are different, e.g. within spectrum characteristics. In the short term, both have a similar coherence time. Hence, the same reference signal configuration can be applied to compensate for RF analog error.

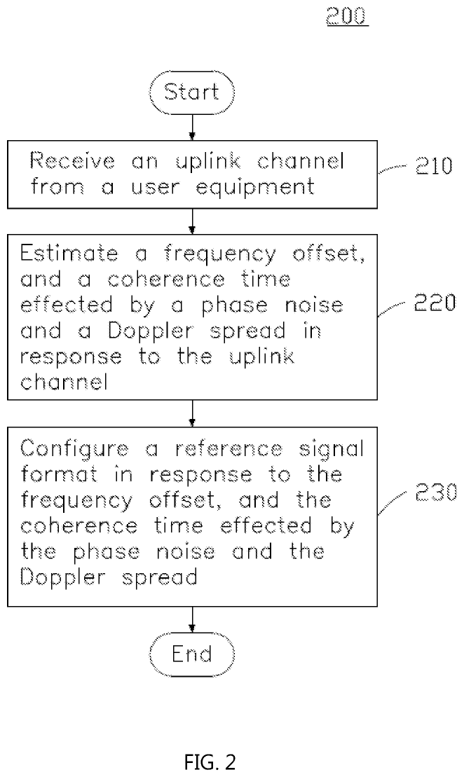

FIG. 2 illustrates a flow chart of a method (method 200) for configuring reference signal of the wireless communication system 100 according to an embodiment. The method 200 comprises the following actions. At block 210, an uplink channel is received by the BS 124 from the UE 110. At block 220, a frequency offset and a coherence time affected by a phase noise and a Doppler shift are estimated by the BS 124 in response to the uplink channel. At block 230, a reference signal format is configured by the BS 124 in response to the frequency offset and the coherence time affected by the phase noise and the Doppler shift.

In one embodiment, the uplink channel is a physical random access channel (PRACH). In another embodiment, the uplink channel is a physical uplink control channel (PUCCH).

In one embodiment, the reference signal format comprises a demodulation reference signal (DM-RS). In another embodiment, the reference signal format comprises a phase-tracking reference signal (PT-RS).

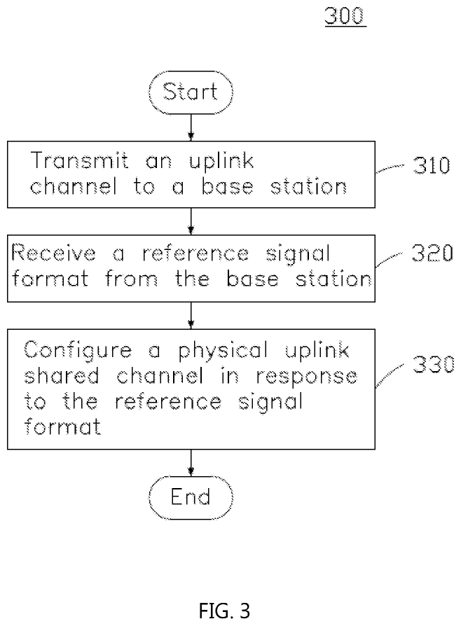

FIG. 3 illustrates a flow chart of another method (method 300) according to another embodiment. The method 300 comprises the following actions. At block 310, an uplink channel is transmitted by the UE 110 to the BS 124. At block 320, a reference signal format is received by the UE 110 from the BS 124. In block 330, a physical uplink shared channel is configured by the UE 110 in response to the reference signal format.

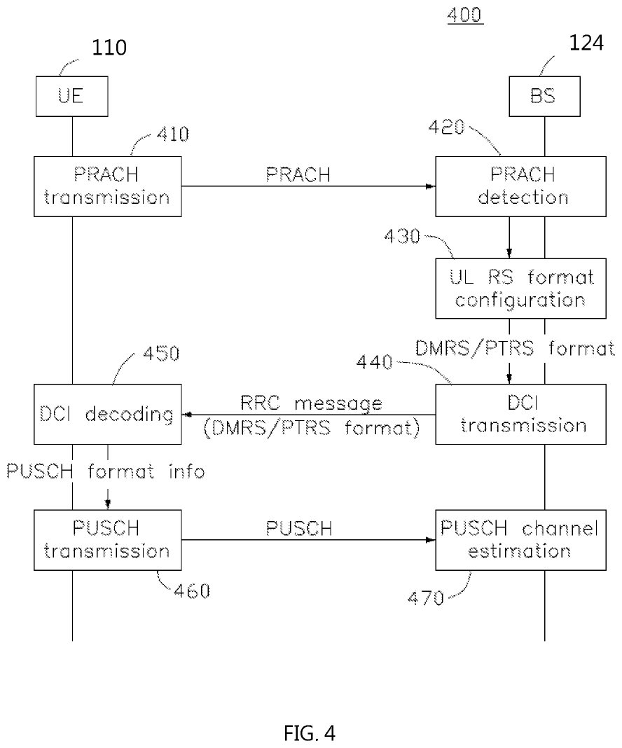

FIG. 4 illustrates a schematic diagram of another method (method 400) according to another embodiment. In this embodiment, the uplink channel is a PRACH.

At block 410, the UE 110 transmits a PRACH to the BS 124.

At block 420, the BS 124 receives the PRACH from the UE 110 and performs a PRACH detection to estimate a frequency offset and a coherence time affected by the phase noise and the Doppler shift. In one embodiment, the frequency offset comprises a carrier frequency offset, a phase noise, and Doppler spread.

At block 430, the BS 124 configures a reference signal format in response to the frequency offset and the coherence time. In one embodiment, the reference signal format comprises the DM-RS. In another embodiment, the reference signal format comprises the PT-RS. In some implementations, a time density of the reference signal (e.g., DM-RS or PT-RS) is configured. In other embodiment, a frequency density of the reference signal (e.g., DM-RS or PT-RS) is configured.

At block 440, the BS 124 transmits the reference signal format to the UE 110 using a Radio Resource Control (RRC) message (e.g., downlink control information (DCI) transmission).

At block 450, the UE 110 decodes the DCI and configures a physical uplink shared channel (PUSCH) in response to the received reference signal format.

At block 460, the UE 110 transmits the PUSCH to the BS 124.

At block 470, the BS 124 performs a PUSCH channel estimation in response to an uplink impulse response of the received PUSCH.

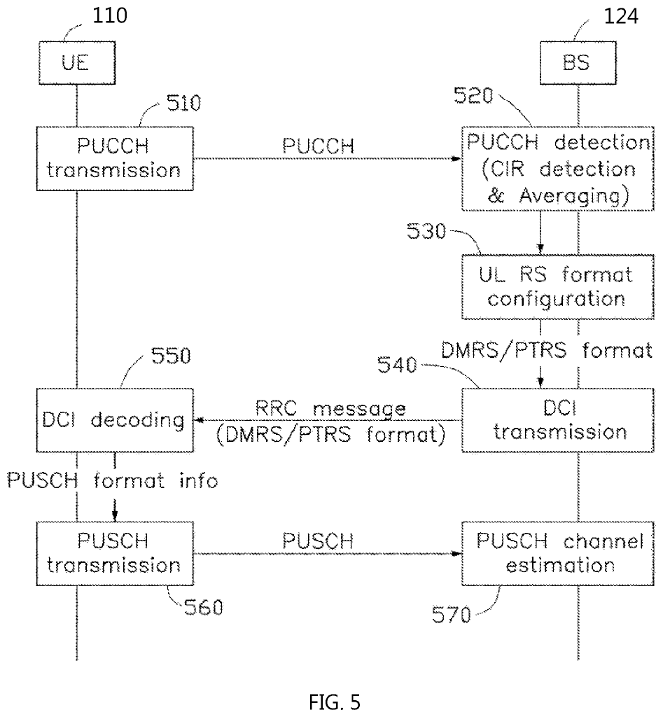

FIG. 5 illustrates a reference signal configuration of the wireless communication system 100 according to another embodiment. In this embodiment, the uplink channel is a PUCCH.

At block 510, the UE 110 transmits a PUCCH to the BS 124.

At block 520, the BS 124 receives the PUCCH from the UE 110 and performs a PUCCH detection (e.g., channel impulse response (CIR) detection and averaging) to estimate a frequency offset, and a coherence time affected by the phase noise and the Doppler shift. In one implementation, the frequency offset includes a carrier frequency offset, a phase noise, and Doppler spread.

At block 530, the BS 124 configures a reference signal format in response to the frequency offset and the coherence time. In one embodiment, the reference signal format includes a demodulation reference signal (DM-RS). In another embodiment, the reference signal format includes a phase-tracking reference signal (PT-RS). In some embodiments, a time density of the reference signal (e.g., DM-RS or PTRS) is configured. In some other embodiments, a frequency density of the reference signal (e.g., DM-RS or PTRS) is configured.

At block 540, the BS 124 transmits the reference signal format to the UE 110 using an RRC message (e.g., downlink control information (DCI) transmission).

At block 550, the UE 110 decodes the DCI and configures a physical uplink shared channel (PUSCH) in response to the received reference signal format.

At block 560, the UE 110 transmits the PUSCH to the BS 124.

At block 570, the BS 124 performs a PUSCH channel estimation in response to an uplink impulse response of the received PUSCH.

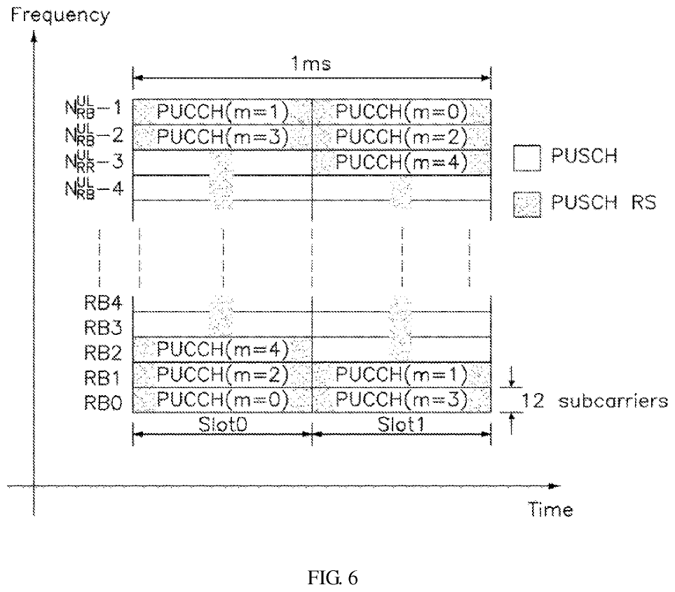

FIG. 6 illustrates resource allocation of a PUCCH format with a frequency hopping feature, according to one embodiment. As shown in FIG. 6, there are two slots in one sub-frame (e.g., 1 millisecond). The resources blocks (RBs) assigned for the PUCCH are located on the band edges of the channel bandwidth within the sub-frame, and the rest of the RBs remain for the PUSCH. When the frequency hopping feature is used, a lower end of the available UL resources is used in the first slot of the sub-frame and a higher end is used in the second slot, and thus the level of frequency diversity is increased.

For example, a PUCCH (e.g., m=0) is transmitted at the lowest RB (e.g., RB0) in the first slot (e.g., Slot 0), and the same PUCCH (e.g., m=0) is retransmitted at the highest RB (e.g., N_{RB}^{UL}−1) in the second slot (e.g., Slot 1), where m is an index of the PUCCH resource, and the NRBUL is the number of the uplink resource blocks. Another PUCCH (e.g., m=1) is transmitted at the highest RB (e.g., N_{RB}^{UL}−1) in the first slot (e.g., Slot 0), and the same PUCCH (e.g., m=0) is retransmitted at the lowest RB (e.g., RB0) in the second slot (e.g., Slot 1). The remaining resources blocks for the PUCCH are allocated in a similar way. With increasing m, the allocated resource blocks move towards the center of the frequency band, as shown in FIG. 6.

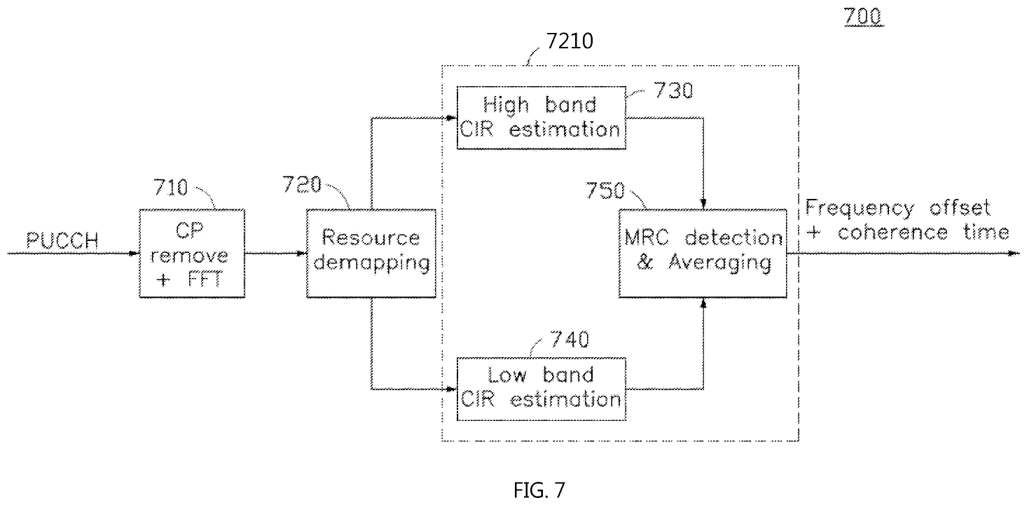

FIG. 7 illustrates PUCCH detection according to one embodiment.

At block 710, the Cyclic Prefixes (CPs) is removed and a fast Fourier transform is performed.

At block 720, a resource de-mapping is performed.

At block 7210, a CIR detection and averaging is performed to estimate a frequency offset. In one embodiment, in order to achieve the frequency hopping feature, CIR is estimated individually for the higher band edge and for the lower band edge since the fast fading channel is independent. Also, the instantaneous channel quality or signal strength (e.g., signal-to-interference-plus-noise ratio (SINR)) at the band edges could be affected by the fast fading fluctuation, and therefore a maximum ratio combining (MRC) detection and averaging is performed for the higher band edge and the lower band edge.

For example, at block 730, a CIR estimation is performed on the higher band edge to generate a first frequency offset. At block 740, a CIR estimation is performed on the lower band edge to generate a second frequency offset. At block 750, a MRC detection and averaging is performed on the first frequency offset and the second frequency offset to generate the estimated frequency offset. In one embodiment, the frequency offset comprises a carrier frequency offset, a phase noise, and Doppler spread.

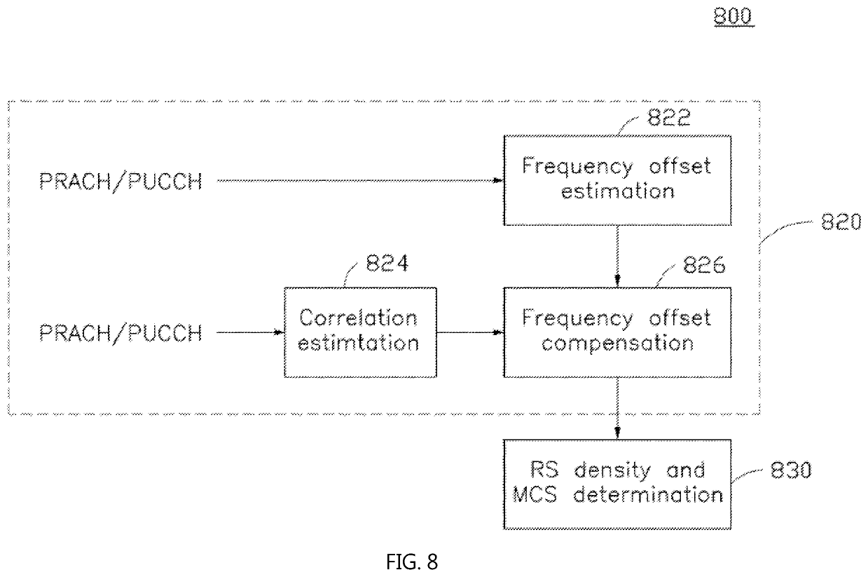

FIG. 8 illustrates a reference signal configuration of the wireless communication system 100 according to another embodiment. In the embodiment, the method may be applied for a PRACH or a PUCCH detection.

At block 820, the BS 124 performs a PRACH detection or a PUCCH detection to estimate a frequency offset and a coherence time affected by the phase noise and the Doppler shift.

At block 822, the frequency offset is estimated. In one embodiment, when a PRACH is received, a signature detection process is performed on two sequences of the PRACH. In another implementation, when a PUCCH is received, the carrier frequency offset is estimated based on the cyclic prefix of an OFDM signal.

At block 824, a correlation estimation which estimates a correlation level corresponding to the coherence time is performed. In one embodiment, when a PRACH is received, a signature detection process is performed on two sequences of the PRACH and then the complex signal peak position is detected for the two sequences. Afterwards, the correlation level between the two complex signals is calculated. For example, a correlation level corresponding to the coherence time is calculated by the formula R_{C}(ΔT_{C})=E[x(t)−x*(t−ΔT_{C})], where x(t) is the received PRACH signature at time t, x(t−Tc) is the received PRACH signature at time t−Tc, Tc is a measurement interval, and * is complex conjugate.

In another embodiment, when a PUCCH is received, the two DM-RS from two slots are received for estimating the channel (e.g., CIR). The estimated channel coefficients from the two slots are used for calculating the correlation (e.g., coherence time).

After the correlation is estimated, the estimated correlation comprises a phase noise correlation, a Doppler spread, and the frequency offset. At block 826, the frequency offset (e.g., cos(2π·f_{O}·T_{C})) is compensated for or removed. For example, in the correlation result after the compensation R_{C}, no offset(T_{C}) is represented by R_{C}, no offset (ΔT_{C})=R_{C}(ΔT_{C})−a·cos(2π·f_{O}·ΔT_{C}), where T_{C} is a measurement interval, f_{O} is the frequency offset, and a is a coefficient for amplitude adjustment.

At block 830, the reference signal (RS) density and the MCS are determined in response to the estimated correlation level after the frequency offset compensation. Table 1 shows a time density configuration of the PT-RS, where ptrs-MCS are the threshold values, and i=1, 2, 3. Table 2 shows a frequency density configuration of the PT-RS, where N_{RBi} represent the threshold values, and i=0, 1.

TABLE 1

| Scheduled MCS | Time density (L_{PT-RS}) |
|---|---|
| I_{MCS} < ptrs-MCS₁ | PT-RS is not present |
| ptrs-MCS₁ ≤ I_{MCS} < ptrs-MCS₂ | 4 |
| ptrs-MCS₂ ≤ I_{MCS} < ptrs-MCS₃ | 2 |
| ptrs-MCS₃ ≤ I_{MCS} < ptrs-MCS₄ | 1 |

TABLE 2

| Scheduled bandwidth | Frequency density (K_{PT-RS}) |
|---|---|
| N_{RB} < N_{RB0} | PT-RS is not present |
| N_{RB0} ≤ N_{RB} ≤ N_{RBI} | 2 |
| N_{RB1} ≤ N_{RB} | 4 |

In one implementation, the channel estimation may compensate for the degradations caused by the Doppler shift and the phase noise if the density of the reference signal is enough to reproduce the Doppler shift and the phase noise. On the other hand, high density of the reference signal increases the redundancy of the uplink transmission. The appropriate density should be determined based on the actual Doppler shift and the phase noise.

In this embodiment, the time density threshold values (e.g., ptrs-MCSi) or the frequency density values (e.g., N_{RBi}) may be adjusted in response to the coherence time affected by the phase noise and the Doppler shift (after the frequency offset compensation). For example, when the correlation level (after the frequency offset compensation) corresponding to the coherence time (e.g., R_{C,no} offset(ΔT_{C})) is greater than or equal to a threshold, which means that the channel variation is slow, a higher MCS is assigned and a lower density is configured, and thus only the DM-RS is used. Alternatively, when the correlation level corresponding to the coherence time is less than the threshold, which means that the channel variation is fast, a lower MCS is assigned and a higher density is configured, and thus one or more PT-RS are used.

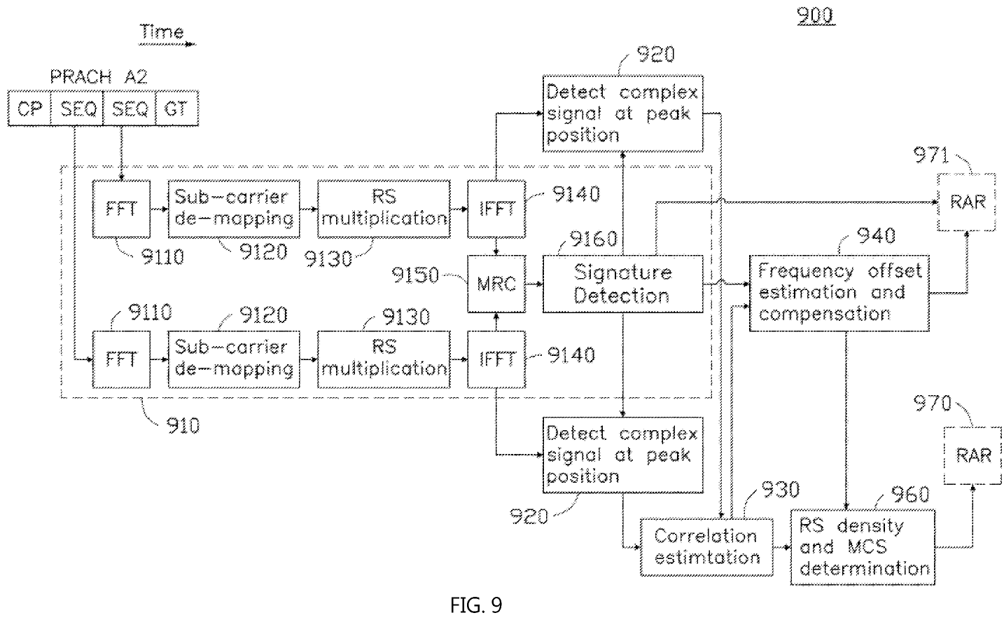

FIG. 9 illustrates a reference signal configuration of the wireless communication system 100 according to one embodiment. In the embodiment, a PRACH is applied. In the wireless communication system 100, the BS 124 may receive the same PRACH sequence multiple times. The number of times the PRACH sequence(s) is received can be specified by the format type. For example, the minimum repetition format is 2 in PRACH A2. In the embodiment, a PRACH A2 format is used.

FIG. 9 shows blocks 910, 920, 930, 940, 950, 960, and 961. At block 910, the BS 124 may receive multiple uplink sequences (e.g., a first PRACH sequence and a second PRACH sequence) from an uplink channel (e.g., PRACH). Only two uplink sequences are shown as received and processed in FIG. 9, but the present disclosure is not limited thereto. In some embodiments, the number of uplink sequences received and processed by the BS 124 can be up to 12. In another embodiment, the uplink channel may be a Physical Uplink Control Channel (PUCCH) or a Physical Uplink Shared Channel (PUSCH).

The block 910 may comprise a fast Fourier transform (FFT) procedure 9110, a sub-carrier de-mapping procedure 9120, a reference signal multiplication procedure 9130, and an inverse fast Fourier transform (IFFT) procedure 9140. The procedures 9110, 9120, 9130, and 9140 may comprise a function similar to that of the LTE PRACH signature detection process, and can be replaced by other signal detection hardware and/or software implementations.

The block 910 may further comprise a Maximum Ratio Combining (MRC) procedure 9150 and a signature detection procedure 9160. The MRC procedure 9150 may output a result of combined received uplink sequences. The signature detection procedure 9160 may determine channel signature information based on the combined result. In one embodiment, the channel signature information may comprise a power delay profile. In another embodiment, the channel signature information may be provided to the RAR procedure 971 for providing an RAR to the UE 110.

In some embodiments, the MRC procedure 9150 may be replaced by other optimized combining procedure(s). In one embodiment, the MRC procedure 9150 may be replaced by a coherent accumulation procedure.

At block 920, the BS 124 may detect multiple complex signals at peak positions from the uplink sequences based on the channel signature information. In one embodiment, the BS 124 may also estimate the peak position in the block 910.

Furthermore, at block 920, the BS 124 may output multiple complex signals located at the peak positions in the power delay profile. As shown in FIG. 9, two complex signals may be outputted from the two blocks 920, respectively, where one is for the first PRACH sequence and the other is for the second PRACH sequence.

At block 930, the BS 124 may estimate a correlation level based on the complex signals. The correlation level may reflect the coherence time of the received signal. For example, a lower correlation level may correspond to a shorter coherence time.

In one embodiment, at block 930, the BS 124 may calculate the correlation level between the complex signal of the first PRACH sequence and the complex signal of the second PRACH sequence. For example, a correlation level corresponding to the coherence time can be calculated by the formula R_{C}(ΔT_{C})=E[x(t)·x*(t−ΔT_{C})], where x(t) is the received PRACH signature at time t, x(t−T_{C}) is the received PRACH signature at time t−T_{C}, Tc is a measurement interval, and * is complex conjugate.

At block 940, the base station may estimate a frequency offset based on the channel signature information (e.g., the power delay profile), and compensate (or remove) the estimated frequency offset (e.g., cos(2π·fo·Tc)) based on the channel signature information. In one embodiment, the BS 124 may determine multiple power peak levels from the received uplink sequences based on the power delay profile, and estimate the frequency offset based on the power peak levels. For example, based on the power delay profile, the BS 124 may estimate the frequency offset by comparing the first peak level of power delay profile corresponding to the first PRACH sequence and the second peak level of power delay profile corresponding to the second PRACH sequence.

The estimated correlation level may comprise a phase noise correlation, a Doppler spread, and the frequency offset. The frequency offset may cause bias of the estimated correlation level.

The output of block 940 can be further used for the RS density and the MCS determination procedure (block 960). The correlation level after the compensation R_{C, no offset}(T_{C}) can be represented by formula R_{C,no offset}(ΔT_{C})=R_{C}(ΔT_{C})−a·cos(2π·fₒ·ΔT_{C}) where T_{C} is a measurement interval, fₒ is the frequency offset, and “a” is a coefficient for amplitude adjustment.

At block 960, the BS 124 may determine a density of a reference signal and a Modulation and Coding Scheme (MCS) based on the correlation level. For example, the reference signal may be the DM-RS or the PT-RS.

In one embodiment, the BS 124 may perform an RS density and MCS determination procedure to determine the appropriate RS density set and MCS, and output the results to the random access response (RAR) procedure (e.g., block 970 and 971). The RAR procedure may assign the determined RS density and MCS for the uplink transmission.

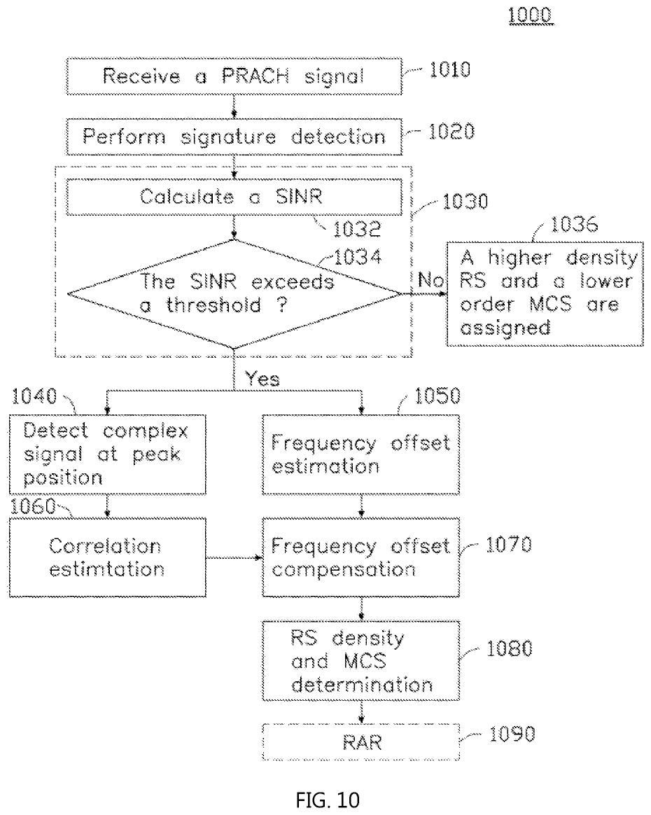

FIG. 10 illustrates a flowchart of a method (method 1000) of a reference signal configuration of the wireless communication system, according to another embodiment.

At block 1010, a PRACH signal is received.

At block 1020, a signature detection process is performed. In one embodiment, the signature detection process may be used for the RAR procedure.

At block 1030, a channel quality is estimated. In the embodiment, the decision process detecting the received SINR and determining whether the received SINR satisfies the threshold level for the time correlation estimation is introduced in the determination flow. For example, at block 1032, an SINR is calculated. At block 1034, whether or not the SINR exceeds a threshold is determined. When the SINR does not exceed the threshold, a higher density RS and a lower MCS are assigned at block 1036.

When the SINR does exceed the threshold, multiple complex signals are detected at the peak position at block 1040, and the frequency offset is estimated at block 1050. After the complex signals are detected at the peak position, the correlation level between the detected complex signals is estimated at block 1060. After the frequency offset is estimated and the correlation level between the detected complex signals are estimated, the estimated frequency offset can then be compensated for (or removed) at block 1070. Afterwards, the RS density and MCS determination are determined at block 1080, and the RS configuration is then outputted to the RAR procedure at block 1090.

Generally, the estimation of the correlation estimation is worse under a lower SINR because both the interference and the noise cause an unnecessary bias of the estimation. Therefore, under a lower SINR environment, despite the result of estimation, a lower order MCS would be selected in order to improve the BLER performance, and a higher density of reference signal would be selected to improve the channel estimation performance.

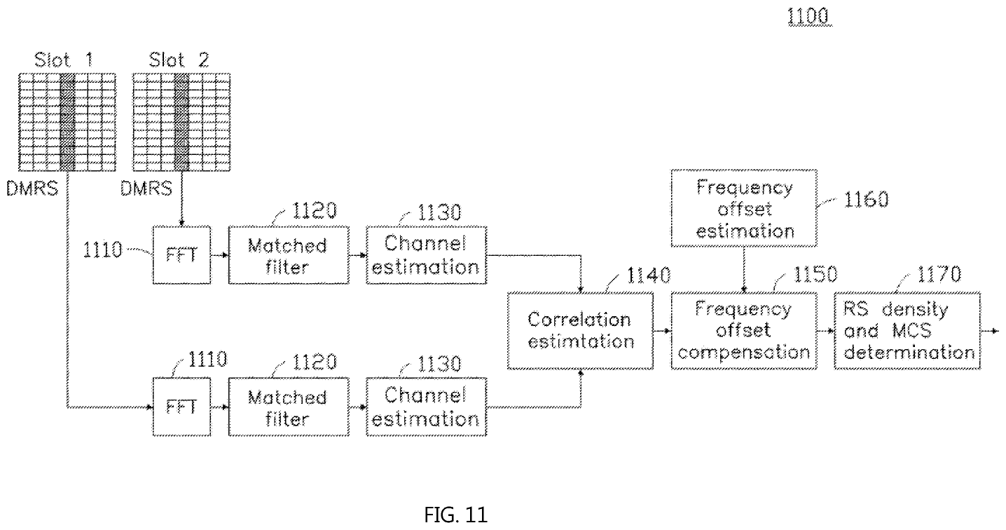

FIG. 11 illustrates a reference signal configuration according to another embodiment. In this embodiment, the DM-RS of a PUCCH is applied.

At block 1110, an FFT procedure is performed on each of slot 1 and slot 2 of the DM-RS of the PUCCH.

After the FFT procedures, the output signals are inputted to the matched filter. At block 1120, the matched filter generates the estimated channel impulse response.

At block 1130, a channel estimation procedure is performed to generate the estimated channel coefficients from slot 1 and slot 2.

At block 1140, a correlation estimation is performed to output the time correlation between slot 1 and slot 2. The time correlation between slot 1 and slot 2 comprises a frequency offset. Therefore, at block 1150, a frequency offset compensation procedure is performed to compensate for the frequency offset. The frequency offset is estimated by the frequency offset estimation procedure as shown at block 1160 according to the correlation of cyclic prefix of OFDM symbols.

After the frequency offset compensation, an RS density and MCS are determined and the selected RS density and MCS for the uplink transmission are assigned at block 1170.

Some embodiments, as shown in FIGS. 9 and 11, may use a snapshot measurement for the MCS determination procedure. This also works to detect the phase noise because it reflects the latest phase noise measurement. The coherent accumulation procedure may further improve the detection of the phase noise measurement. In general, continuing the transmissions is useful for the coherent accumulation procedure.

As shown in FIG. 4 and FIG. 5, until the UE 110 configures the PUSCH, a signaling procedure using PRACH and PUCCH is necessary. However, the transmission for the signaling eventually occurs to avoid unnecessary transmission and improve power consumption of the UE 110. Applying the coherent accumulation procedure for PRACH and PUCCH is difficult because it requires periodical samples.

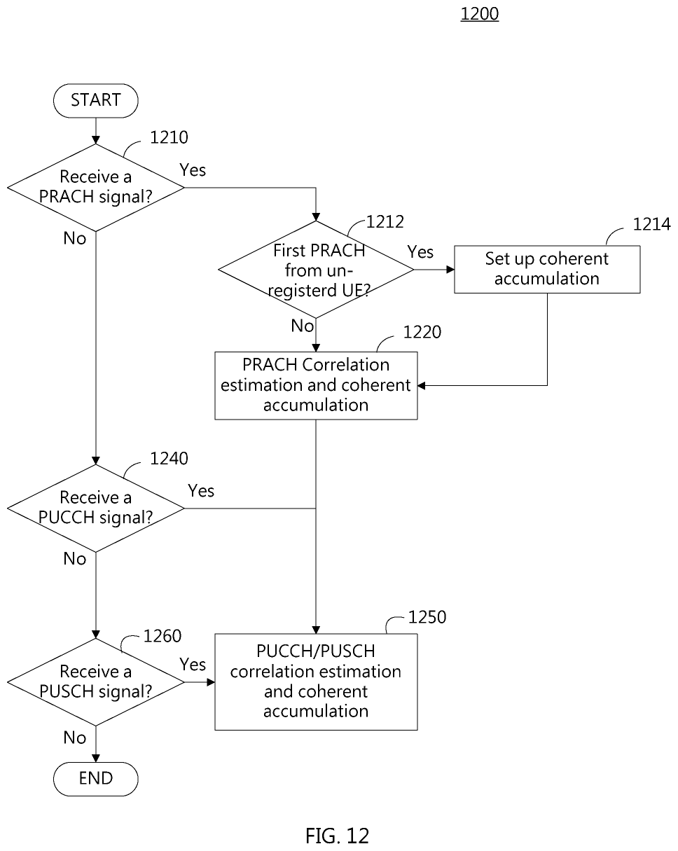

FIG. 12 illustrates a flowchart of a method (method 1200) of a reference signal configuration of the wireless communication system 100 according to another embodiment.

In the embodiment, the method 1200 may be performed by the BS 124. In order to support the coherent accumulation procedure for aperiodic uplink signal reception, a UE ID based buffer for the correlation and coherent accumulation is arranged by the BS 124.

Whenever the BS 124 receives a radio signal, the BS 124, at block 1210, first determines whether a PRACH signal is received.

When the BS 124 receives the PRACH signal, the BS 124 may further determine whether the received PRACH is the first from the UE 110 which is not registered at the BS 124, at block 1212. If the received PRACH signal is the first transmission from the unregistered UE 110, a coherent accumulation buffer and a counter for the coherent accumulation buffer is arranged for the UE 110 at block 1214.

At block 1220, the received PRACH signals, first and others, are input to a correlation estimation and coherent accumulation procedure for the PRACH signals.

If the received radio signal is not the PRACH signal, the BS 124 further determines whether the received radio signal is a PUCCH signal, at block 1240.

If the received radio signal is the PUCCH signal, the signal is input to a correlation estimation and coherent accumulation procedure for PUCCH signals and PUSCH signals at block 1250.

If the received radio signal is not the PUCCH signal, the BS 124 further determines whether the received is a PUSCH signal, at block 1260.

If the received radio signal is the PUSCH signal, the received PUSCH signal is input to a correlation estimation and coherent accumulation procedure for PUCCH signals and PUSCH signals, at block 1250.

In one embodiment, if estimation samples can be normalized, continued input signals are not necessary because statistical averaging is required.

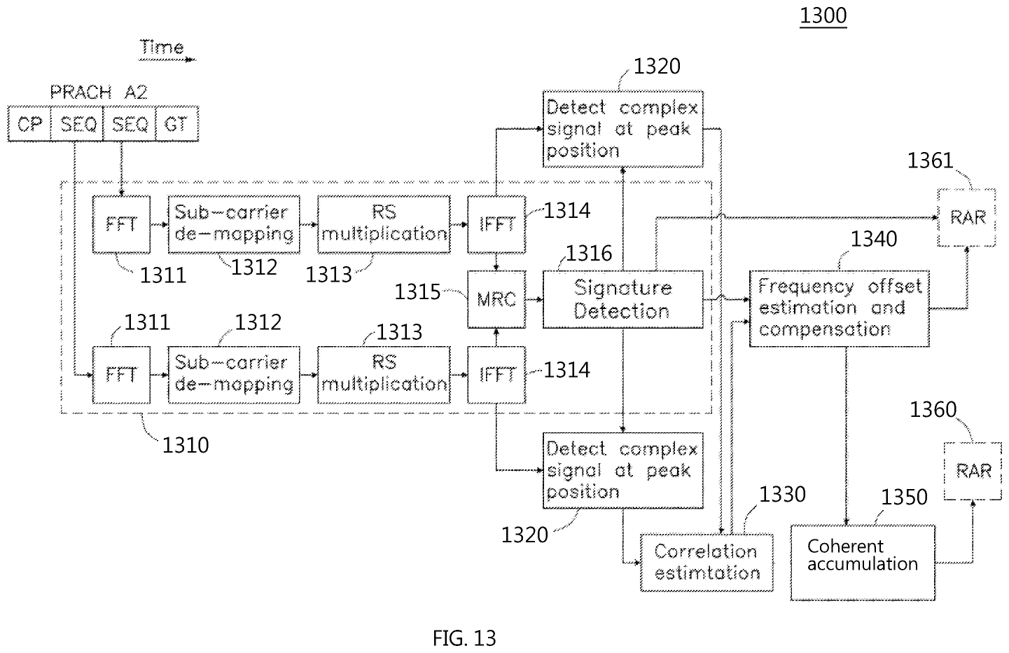

FIG. 13 illustrates a reference signal configuration of the wireless communication system 100 according to one embodiment. In the embodiment, a PRACH is applied. In the wireless communication system 100, the BS 124 may receive the same PRACH sequence multiple times. The number of times the PRACH sequence(s) are received can be specified by the format type. For example, the minimum repetition format is 2 in PRACH A2. In the embodiment, a PRACH A2 format is used.

FIG. 13 shows blocks 1310, 1320, 1330, 1340, 1350, 1360, and 1361. At block 1310, the BS 124 may receive multiple uplink sequences (e.g., a first PRACH sequence and a second PRACH sequence) from an uplink channel (e.g., PRACH). Although FIG. 13 shows only two uplink sequences being received and processed, the present disclosure is not limited thereto. In some embodiments, the number of unlink sequences received and processed by the BS 124 can be up to 12. In another embodiment, the uplink channel may be a Physical Uplink Control Channel (PUCCH) or a Physical Uplink Shared Channel (PUSCH).

The block 1310 may comprise a fast Fourier transform (FFT) procedure 1311, a sub-carrier de-mapping procedure 1312, a reference signal multiplication procedure 1313, and an inverse fast Fourier transform (IFFT) procedure 1314. The procedures 1311, 1312, 1313, and 1314 may comprise a function similar to that of the LTE PRACH signature detection process, and can be replaced by other signal detection hardware and/or software implementations.

The block 1310 may further comprise a Maximum Ratio Combining (MRC) procedure 1315 and a signature detection procedure 1316. The MRC procedure 1315 may output of combined received uplink sequences. The signature detection procedure 1316 may determine channel signature information based on the combined result. In one embodiment, the channel signature information may comprise a power delay profile. In another embodiment, the channel signature information may be provided to the RAR procedure 1371 for providing an RAR to the UE 110.

At block 1320, the BS 124 may detect multiple complex signals at peak positions from the uplink sequences based on the channel signature information. In one embodiment, the BS 124 may also estimate the peak position in the block 910.

Furthermore, at block 1320, the BS 124 may output multiple complex signals located at the peak positions in the power delay profile. As shown in FIG. 9, two complex signals may be outputted from the two blocks 1320 respectively, where one is for the first PRACH sequence and the other is for the second PRACH sequence.

At block 1330, the BS 124 may estimate a correlation level based on the complex signals.

In one embodiment, at block 1330, the BS 124 may calculate the correlation level between the complex signal of the first PRACH sequence and the complex signal of the second PRACH sequence. For example, a correlation level corresponding to the coherence time can be calculated by R_{C}(ΔT_{C})=E[x(t)·x*(t−ΔT_{C})], where x(t) is the received PRACH signature at time t, x(t−T_{C}) is the received PRACH signature at time t−T_{C}, Tc is a measurement interval, and * is a complex conjugate.

At block 1340, the base station may estimate a frequency offset based on the channel signature information (e.g., the power delay profile), and compensate for (or remove) the estimated frequency offset (e.g., cos(2πfo·Tc)) based on the channel signature information. In one embodiment, the BS 124 may determine multiple power peak levels from the received uplink sequences based on the power delay profile, and estimate the frequency offset based on the power peak levels. For example, based on the power delay profile, the BS 124 may estimate the frequency offset by comparing the first peak level of power delay profile corresponding to the first PRACH sequence and the second peak level of power delay profile corresponding to the second PRACH sequence.

The estimated correlation level may comprise a phase noise correlation, a Doppler spread, and the frequency offset. The frequency offset may cause a bias of the estimated correlation level.

The output of block 1340 may be further used for the coherent accumulation procedure (block 1360). The correlation level after the compensation R_{C, no offset}(T_{C}) can be represented by R_{C,no offset}(ΔT_{C})=R_{C}(ΔT_{C})−a·cos(2π·fₒ·ΔT_{C}) where T_{C} is a measurement interval, fₒ is the frequency offset, and “a” is a coefficient for amplitude adjustment.

At block 1350, the BS 124 may perform a coherent accumulation procedure for the estimated correlation. After the correlation is calculated, the calculated correlation may comprise a phase noise correlation, a Doppler spread, and the frequency offset.

In one embodiment, the BS 124 may perform an RS density and MCS determination procedure using the calculated correlation to determine the appropriate RS density set and MCS for the uplink transmission, and output the results to the random access response (RAR) procedure (e.g., block 1370 and 1371). For example, the reference signal may be the DM-RS or the PT-RS. The RAR procedure may assign the determined RS density and MCS for the uplink transmission.

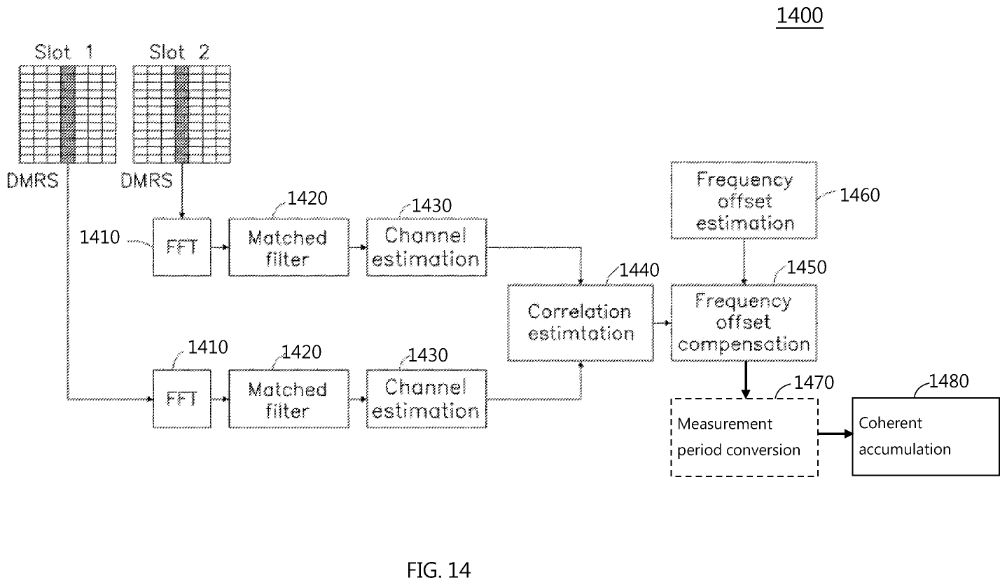

FIG. 14 illustrates a reference signal configuration according to another embodiment. In this embodiment, the DM-RS of a PUCCH is applied.

At block 1410, an FFT procedure is performed on each of slot 1 and slot 2 of the DM-RS of the PUCCH.

After the FFT procedures, the output signals are inputted to the matched filter. At block 1420, the matched filter generates the estimated channel impulse response.

At block 1430, a channel estimation procedure is performed to generate the estimated channel coefficients from slot 1 and slot 2.

At block 1440, a correlation estimation is performed to output the time correlation between slot 1 and slot 2. The time correlation between slot 1 and slot 2 comprises a frequency offset. Therefore, at block 1450, a frequency offset compensation procedure is performed to compensate for the frequency offset. The frequency offset is estimated by the frequency offset estimation procedure as shown at block 1460 according to the correlation of cyclic prefix of OFDM symbols.

At block 1470, if there are no consecutive or contiguous symbols, then the interval between two symbols need to be conversed in order to apply same measurement interval for a coherent accumulation procedure at block 1480.

After the measuring period conversion, the estimated correlation is input to the coherent accumulation procedure, the RS density and the MCS are determined, and the selected RS density and MCS for uplink transmission are assigned.

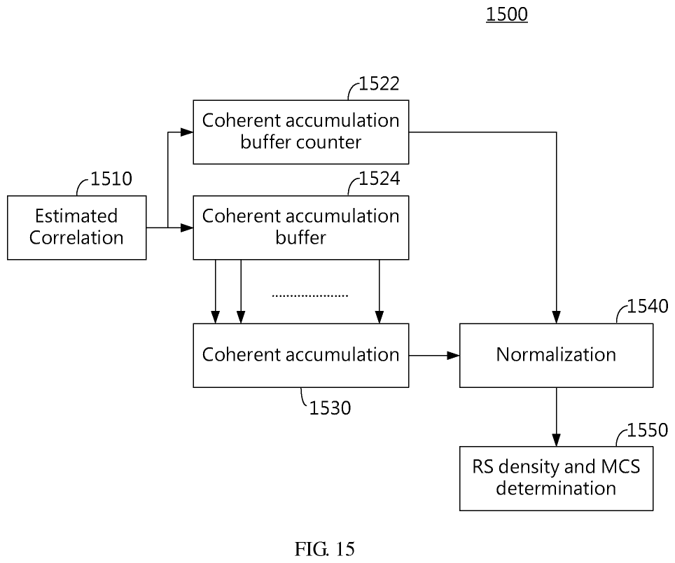

FIG. 15 illustrates a coherent accumulation procedure 1500 of the wireless communication system 100 according to one embodiment.

When a first PRACH from an unregistered UE 110 is received by the BS 124, a coherent accumulation buffer with a memory capacity L is initialized at block 1510, and a counter for counting up number of correlation values in the coherent accumulation buffer is initialized at block 1515. In one embodiment, the number L is predetermined by the BS 124.

After a correlation is estimated by the BS 124 at block 1510, the correlation value is stored into the coherence accumulation buffer.

At block 1530, the BS 124 performs a coherent accumulation process for all correlation values stored in the coherent accumulation buffer.

At block 1540, the output of the coherent accumulation process is normalized by the counter of the coherent accumulation buffer.

The output of block 1540 can be further used for the RS density and the MCS determination procedure (block 1550).

In the embodiment, when the UE 110 is released, i.e. the UE 110 is turned-off or handed over to other cells, the buffer resources are released for the use of other UEs.

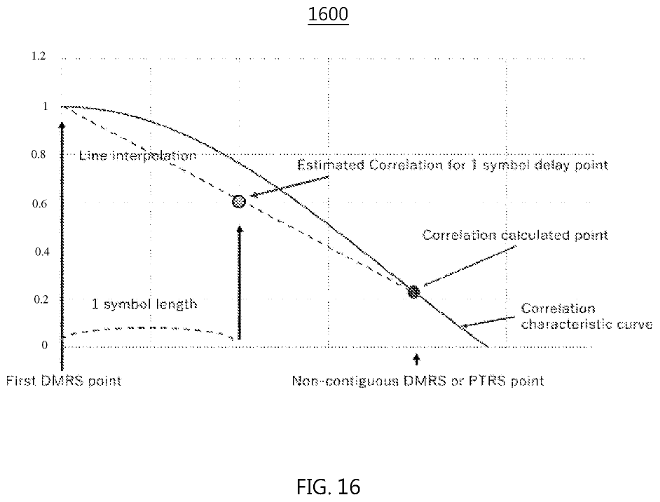

FIG. 16 illustrates the measuring period conversion procedure according to one embodiment. In the embodiment, the measuring period conversion procedure is performed by the BS 124 in order to apply same measurement interval for the coherent accumulation procedure.

For example, in some frame formats, interval of DM-RSs or interval between DM-RS and PTRS is longer than 0 (this means that these are not consecutive or contiguous signals). The calculated correlation level becomes smaller than the consecutive case. Short PRACH continuously repeats the same short sequence, i.e. the consecutive case. Even under same phase noise environment, correlation calculation for PUSCH/PUCCH and correlation calculation for PRACH output different results. One idea is to apply interpolation calculation of PUCCH/PUSCH. In the embodiment, line interpolation is selected because interpolation accuracy is not crucial.

In one embodiment, the conversion is done by the equation Y(ΔT_{S})=((Y_{DM-RS}(T₀)−Y_{DM-RS}(T₁))/(T₀−T₁))*(T₀+ΔT_{S})+Y_{DM-RS}(T₀), where T₀ is a time for first DM-RS, T₁ is a time for non-contiguous DM-RS or PTRS, Y_{DM-RS}(t) is correlation level at time t, and ΔT_{S} is a symbol interval. By performing the measuring period conversion procedure and the coherent accumulation procedure, coherent accumulation can be done with PRACH and PUCCH/PUSCH.

Several methods for power saving for the UE and wireless communication are provided in this disclosure. The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for configuring reference signal, the method comprising:
receiving, by a base station, a plurality of uplink sequences from an uplink channel;
performing, by the base station, an optimal combining procedure on the plurality of uplink sequences to output a combined result of the plurality of uplink sequences;
determining, by the base station, channel signature information based on the combined result;
detecting, by the base station, a plurality of complex signals at peak positions from the plurality of uplink sequences based on the channel signature information;
estimating, by the base station, a first correlation level based on the plurality of complex signals;
coherently accumulation, by the based station, a second correlation level based on the first correlation level; and
determining, by the base station, a density of a reference signal and a modulation and coding scheme based on the second correlation level.

2. The method of claim 1, wherein the uplink channel comprises a physical random access channel (PRACH).

3. The method of claim 2, wherein the uplink sequences for the PRACH are PRACH sequences.

4. The method of claim 1, wherein the uplink channel comprises a physical uplink control channel (PUCCH) and a physical uplink shared channel (PUSCH).

5. The method of claim 4, wherein the uplink sequences for the PUCCH and the PUSCH are demodulation reference signals (DM-RSs).

6. The method of claim 1, wherein optimal combining procedure comprises a maximum ratio combining (MRC) procedure.

7. The method of claim 1, wherein the channel signature information comprises a power delay profile.

8. The method of claim 7, further comprising: determining, by the base station, a plurality of power peak levels from the plurality of uplink sequences based on the power delay profile; and estimating, by the base station, a frequency offset based on the plurality of power peak levels.

9. The method of claim 8, further comprising: compensating, by the based station, the frequency offset based on the channel signature information.

10. The method of claim 1, wherein the reference signal comprises a demodulation reference signal (DM-RS) and a phase tracking reference signal (PT-RS).

11. A base station, comprising:
one or more non-transitory computer-readable media having computer-executable instructions embodied thereon; and
at least one processor coupled to the one or more non-transitory computer-readable media, and configured to execute the computer-executable instructions to:
receive a plurality of uplink sequences from an uplink channel;
perform an optimal combining procedure on the plurality of uplink sequences to output a combined result of the plurality of uplink sequences;
determine channel signature information based on the combined result;
detect a plurality of complex signals at peak positions from the plurality of uplink sequences based on the channel signature information;
estimate a first correlation level based on the plurality of complex signals;
coherently accumulate a second first level based on the first correlation level; and
determine a density of a reference signal and a modulation and coding scheme based on the second correlation level.

12. The base station of claim 11, wherein the uplink channel comprises a physical random access channel (PRACH).

13. The base station of claim 12, wherein the uplink sequences for the PRACH are PRACH sequences.

14. The base station of claim 11, wherein the uplink channel comprises a physical uplink control channel (PUCCH) and a physical uplink shared channel (PUSCH).

15. The base station of claim 14, wherein the uplink sequences for the PUCCH and the PUSCH are demodulation reference signals (DM-RSs).

16. The base station of claim 11, wherein optimal combining procedure comprises a maximum ratio combining (MRC) procedure.

17. The base station of claim 11, wherein the channel signature information comprises a power delay profile.

18. The base station of claim 17, wherein the at least one processor is further configured to execute the computer-executable instructions to:
determine a plurality of power peak levels from the plurality of uplink sequences based on the power delay profile; and
estimate a frequency offset based on the plurality of power peak levels.

19. The base station of claim 18, wherein the at least one processor is further configured to execute the computer-executable instructions to: compensate the frequency offset based on the channel signature information.

20. The base station of claim 11, wherein the reference signal comprises a demodulation reference signal (DM-RS) and a phase tracking reference signal (PT-RS).
